(19) United States
(12) Patent Application Publication
(10) Pub. No.: US 2003/0161773 A1
(43) Pub. Date: Aug. 28, 2003

(54) Method for removing nitrogen oxide with catalyst and a system thereof

(76) Inventors: Bor-Jye Liang, Shichih City (TW); Rueih-Yuh Weng, Hsinchu Hsien (TW)

Correspondence Address: BRUCE H. TROXELL, SUITE 1404, 5205 LEESBURG PIKE, FALLS CHURCH, VA, 22041, US

(21) Appl. No.: 10/119,212

(22) Filed: Apr. 10, 2002

(30) Foreign Application Priority Data
Feb. 22, 2002 (CN) 02105255.7

(51) Int. Cl. B01D 53/56; B01D 53/54; B01D 53/00

(52) U.S. Cl. 423/239.1; 422/168; 422/172

(57) ABSTRACT

A method for reducing nitrogen oxide with a catalyst and a system thereof comprises the following steps: (A) a step of guiding exhaust, selectively guiding the exhaust containing the nitrogen oxide into an oxygen removing reaction room based on the oxygen content of the exhaust. (If both the oxygen content and the temperature of the exhaust are in a required range, it is not necessary to use the oxygen removing reaction room); (B) a step of introducing the oxygen remover, introducing the oxygen remover into the oxygen removing reaction room from the storage vessel based on the consistency of oxygen in the exhaust. (If both the oxygen content and the temperature of the exhaust are in a required range, it is not necessary to introduce the oxygen remover); (C) a step of oxygen removing reaction, the oxygen remover generating an oxygen removing reaction in the reaction room to cause a function of oxygen removal; (d) a step of catalytic reaction, converting the oxygen removed exhaust a catalyst. (A proper reduction agent can be injected as required); and a step of discharging, discharging the catalyzed exhaust.

### BACKGROUND OF THE INVENTION

1. Field of the Invention

The present invention relates to a method for removing nitrogen oxide with catalyst and a system thereof.

2. Description of Related Art

Due to the development of industries, the electricity consumption is unceasingly increasing and various power plant equipment and combustion systems are continuously established in accordance with the human demand. However, the exhaust generated from burning results in the problem of environment protection. The major source of nitrogen oxide (NOx) is a product originated from a burning process while the coal and the petroleum, which are used in our daily life, are made. The secondary source of nitrogen oxide (NOx) is from the discharged end gas during the nitric acid being used or made in a factory. The side effects of Nox to the human body are briefly listed hereinafter:

A. In case of Nox existing in the atmosphere in company with HC (hydrocarbon), it may produce a kind of poisonous chemical smoke after being exposed under ultraviolet rays.

B. If the human body exposes in an environment with excessive consistency of NOx, the NOx will infiltrate the cells of lungs via the respiratory system to hinder the oxygen being delivered to all parts in the body such that the health of the body is threatened directly.

C. The NOx restrains the growths of vegetables and plants and the complete organism's habit may be affected seriously.

D. The acid rain resulting from the NOx can cause dead aquatics and plants, eroded buildings and hair failings.

Currently, countries all over the world have started to seriously control the NOx.

The typical conventional ways for de-nitrification are: the selected catalytic reduction (SCR), the selected non-catalytic reduction (SNCR) and wet de-nitrification technique, wherein, the way of SCR is more popular and important.

Nevertheless, it is undesirable that there are still following defects residing in the method of SCR:

A. The catalyst used is extremely expensive.

B. The equipment used has a huge size: the catalyst bed is considerably large.

C. The initial set up cost is excessively high: The reducing agent needed by the SCR is ammonia and it is necessary to increase a lot of extra equipment for is storing, treating and delivering the ammonia such that it incurs many expenses and the initial set up cost becomes increased greatly. Therefore, the set up cost of the SCR is higher than that of the exhaust generating equipment such as the diesel engine, the boiler or the like in many application fields.

D. It will cause the problem of the second air pollution: If ammonia is treated improperly to occur leakage, it can cause the problem of the second air pollution.

E. The operation cost is excessively high: A great deal of ammonia has to be used while in operation so that a considerably high operation cost is needed.

A comparison table underneath lists various techniques of de-nitrification:

| | | | | | | Possible | |
|---|---|---|---|---|---|---|---|
| Controlled | | Removing | Space | | Status of skill | secondary | |
| technique | Expense | rate | needed | Principle | development | pollution | Remark |
| Improvement | Low | 15-30 | No | NOx is restrained by | At the stage | No | No |
| of burning | | | | way of decreasing the | of practically | | |
| | | | | consistency of oxygen | used. | | |
| | | | | in the burning zone, | | | |
| | | | | shortening the | | | |
| | | | | stagnation time in the | | | |
| | | | | high temperature zone | | | |
| | | | | and reducing the | | | |
| | | | | burning temperature | | | |
| Low NOx | Low | 30-60 | No | NOx is restrained by | Commercial- | No | Limited |
| burner | | | | way of decreasing | ized | | removal rate |
| | | | | the consistency of | | | |
| | | | | oxygen in the | | | |
| | | | | burning zone, | | | |
| | | | | shortening the | | | |
| | | | | stagnation time in | | | |
| | | | | the high temperature | | | |
| | | | | zone and reducing | | | |
| | | | | the burning | | | |
| | | | | temperature | | | |
| Selected | Medium | 30-60 | Smaller | NH₃ is injected in the | Commercial- | Ammonia | Not suitable for |
| non- | | | than | high temperature | ized | leakage | fuel with high |
| catalytic | | | SCR | zone under the | | | sulfur |
| reduction | | | | condition of no | | | |
| (SNCR) | | | | catalyst, NOx is | | | |
| | | | | reduced and | | | |
| | | | | removed within an | | | |
| | | | | optimal range of | | | |
| | | | | reaction temperature | | | |
| | | | | 870-1000° C. | | | |
| Selected | High | 80-90 | Reactor | NH₃ is used as the | Commercial- | The | Not suitable for |
| catalytic | | | and | reducing agent, NOx | ized | catalyst is | fuel with high |
| reduction | | | storage | on the catalyst is | | aged and | sulfur |
| (SCR) | | | trough | removed by way of | | discarded | |
| | | | are | the selected | | and | |
| | | | installed | reduction, and the | | ammonia | |
| | | | | optimal reaction | | is leaked | |
| | | | | temperature is in a | | (small | |
| | | | | range of 280-400° C. | | amount) | |
| Electronic | High | >80 | Power | NOx is oxidized by | A leading | The | Used with dry |
| light beam | | | utility | way of electronic | test is in a | discard | FGD |
| | | | and | light raying and | state of | | |
| | | | reaction | neutralizes with NH₃ | being | | |
| | | | room | to form solid | developed | | |
| | | | | substances for being | | | |
| | | | | recovered | | | |
| Wet de- | High | >80 | A reactor | Lye, oxidizer and | A leading | Waste | A de- |
| ntrification | | | and | reducing agent are | test is in a | water and | sulfurizing and |
| | | | agent | utilized to remove | state of | solid | de-nitrifying |
| | | | adding | NOx by way of | being | discard | system can be |
| | | | equipment | absorption-oxidation, | developed | | developed |
| | | | | oxidation-absorption | | | |
| | | | | or oxidation- | | | |
| | | | | absorption-reduction | | | |

It can be learned from the above comparison table that various conventional ways for removing nitrogen oxide have their own advantages and disadvantages. Hence, it is believed that any one of the preceding conventional ways is imperfect.

### SUMMARY OF THE INVENTION

A method for reducing nitrogen oxide with a catalyst and a system thereof according to the present invention comprises the following steps: (A) a step of guiding exhaust, selectively guiding the exhaust containing the nitrogen oxide into an oxygen removing reaction room based on the oxygen content of the exhaust. (If both the oxygen content and the temperature of the exhaust are in a required range, it is not necessary to use the oxygen removing reaction room); (B) a step of introducing the oxygen remover, introducing the oxygen remover into the oxygen removing reaction room from the storage trough based on the consistency of oxygen in the exhaust. (If both the oxygen content and the temperature of the exhaust are in a required range, it is not necessary to introduce the oxygen remover); (C) a step of oxygen removing reaction, the oxygen remover generating an oxygen removing reaction in the reaction room to cause a function of oxygen removal; (d) a step of catalytic reaction, converting the oxygen-removed exhaust with a catalyst and a proper reduction agent can be injected as required; and (E) a step of discharging, the catalyzed exhaust being discharged to the open air.

### BRIEF DESCRIPTION OF THE DRAWINGS

The present invention can be more fully understood by reference to the following detailed description and an accompanying drawing, in which:

FIG. 1 is a system diagram for removing nitrogen oxide with catalyst according to the present invention.

### DETAILED DESCRIPTION OF THE PREFERRED EMBODIMENTS

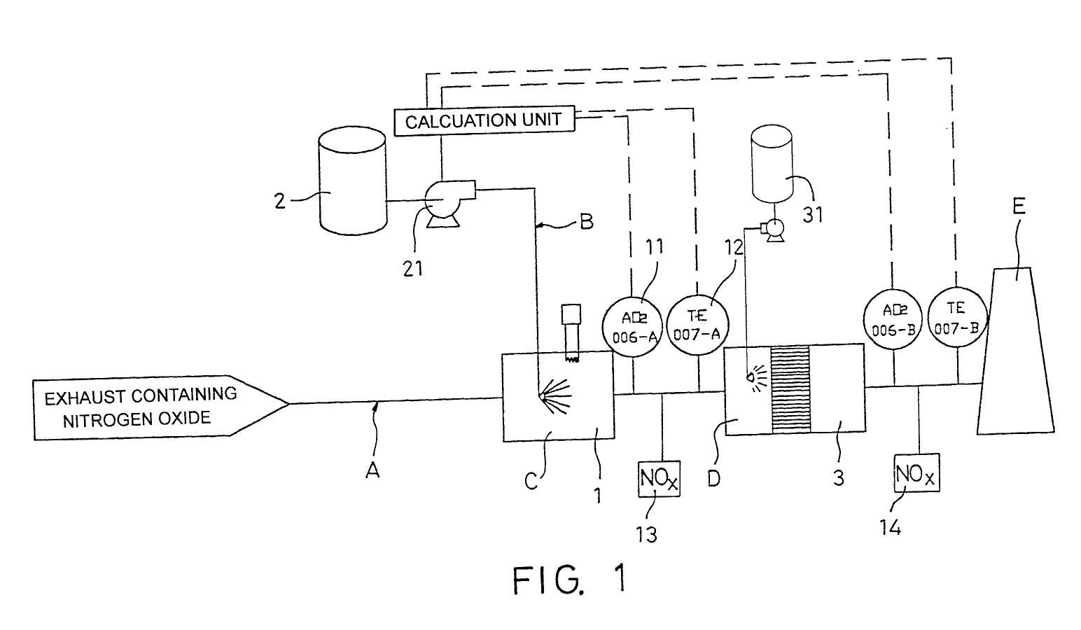

Referring to FIG. 1, basically, a method for removing nitrogen oxide according to the present invention comprises a step of guiding exhaust A, a step of introducing oxygen remover B, a step of removing oxygen C, a step of catalyst reaction D and a step of exhaust discharging E.

Wherein, the step of guiding exhaust A is to guide the originally discharged exhaust into an oxygen removing reaction room 1 with a pipeline for further oxygen removing reaction to an extent that the oxygen content of the exhaust can be treated with the catalyst. Therefore, if the oxygen content of the exhaust is within a preset range, such as 0-5%, the step A can be neglected.

The step of introducing oxygen remover B is to supply the oxygen removable substance in a storage vessel 2 by way of a pipeline. The oxygen removable substance is not limited as the organic complex such as gasoline, diesel fuel, heavy oil, kerosene, stain removing oil, gas, natural gas, coal, hydrogen, methanol, ethanol, propanol, butanol, methane, ethane, propane, or benzene or bio-oil, or the acutely reactive metal such as sodium or magnesium, or the oxygen remover such as powder (nitride). In order to be supplied with a proper amount of the oxygen removable substance, a deliver pump/wind mill 21 can be used and the deliver pump can be detectably controlled with a calculated delivered amount. It is noted that the step B can be omitted in case of the oxygen content being in a preset range such as 0-5%.

The step of removing oxygen C is to operate an ignition device such as igniting an ignition rod and to produce an oxygen removing reaction for the preceding oxide such that the nitrogen oxide residue can be reduced to an extent of the oxygen content of the exhaust being treated with the catalyst. Thus, the output exhaust after the oxygen removing reaction can be detected the oxygen content thereof with an oxygen detection apparatus 11 and the temperature thereof with a temperature detection apparatus 12 such that the pumped amount of the oxygen remover and the temperature of the exhaust can be adjusted in accordance with the detected values. Besides, in order to detect the consistency of the nitrogen oxide, a nitrogen oxide detection apparatus 13, 14 can be added in front of and in back of the oxygen detection apparatus 11 and the temperature detection apparatus 12.

The step of catalyst reaction D is to treat the oxygen removed exhaust by way of a catalyst apparatus 3 after the oxygen removing reaction. The catalyst used in the reaction is oxidation-reduction catalyst such as palladium or the like and the loader for the catalyst can be made of metal, ceramics and etc. with a flat shape or a honeycomb arrangement. Further, a reducing agent vessel 31 is provided to communicate with the catalyst apparatus 3 for supplying the reducing agent by way of a controllable pump.

The step of discharging E is to discharge the catalyzed exhaust via a funnel such that the nitrogen oxide in the exhaust can be reduced to an extent of being less contaminated.

In order to prove the method disclosed in the present invention being practicable, following two embodiments will be explained in detail to verify the practicability thereof.

Embodiment 1:

Simulated experimental example:

Equipment: Reaction test apparatus in the laboratory

Catalyst: PM oxidation-reduction catalyst is adopted.

Speed in the catalyst space: 12,000 L/H

Temperature controlled in the reaction tester: 350° C.

Simulated gas for nitrogen oxide (NOx): Nitrogen monoxide (NO)

Oxide remover and simulated reducing agent gas: Propylene (C₃H₈)

The gaseous nitrogen monoxide (NO) with consistency of 1100 ppm is injected into the reaction test apparatus together with the propylene (C₃H₈) with consistency of 900 ppm and the consistency of oxygen (O₂) in the nitrogen monoxide (NO) is removed to an extent of 0.5% original consistency.

Test result:

Range of reaction temperature is 100-610° C.

When the ration of the gaseous nitrogen monoxide (NO) to propylene (C₃H₈) (NO/HC ration) is less than 20, the conversion efficiency of the nitrogen monoxide is 80%.

When the ration of propylene(C₃H₈) to oxygen (O₂) is less than 1.4, the conversion efficiency of the nitrogen monoxide (NO) is 95%.

Embodiment 2:

A. The exhaust source containing nitrogen oxide (NOx):

Data rationed running power of the diesel engine unit: 100 KW (Kilowatts)

I) Flow rate of dry base exhaust: 10 Nm³/min (cubic meter/minute, at a state of 0° C. and 1 atmosphere without vapor).

II) The oxygen content (O₂) of the exhaust: 10%.

III) The nitrogen oxide (NOx): 501 ppmdv (dry volume ratio in per one millionth)

B. The oxygen remover (fuel):

Diesel fuel (thermal value about 8,800 kcal/liter).

C. The catalyst:

Precious metal catalyst (Palladium or other special elements).

Loader for the catalyst: Metal honeycomb loader with 100 cell/in² (number of holes in an area of square inches).

D. Technique for controlling the oxygen content of the exhaust:

The oxygen content of the exhaust generating from ordinary combustion is about 3-15% and the selected oxygen remover is injected into the reaction room for removing the oxygen or into the exhaust system to consume the oxygen in the exhaust.

※ The amount of required diesel fuel in the embodiment 2 can be figured out as the following:

1) The mole's number per minute of oxygen in the exhaust:

10 Nm³/min*10%*1000 liter/m³÷22.4 liter/mole @0° C. 1 atm=44.6 mole/min

2) Reaction formula for oxygen removal:

Suppose the mean molecular formula of the diesel fuel is C₈H₁₈, the required mole number of oxygen per mole of the diesel fuel during the reaction of oxygen removal is shown in the following reaction formula:

1C₈H₁₈+12.5O₂→8CO₂+9H₂O

3) The required flow rate of the oxygen remover: The consistency of oxygen (02) in the exhaust is reduced to 6% from 10% and the flow rate of the required injected diesel fuel is:

The flow rate of the diesel fuel calculated in embodiment 2: The oxygen has to be reduced to 26.8 mole/min from 44.6 mole/min and it is necessary to consume 17.8 mole/min oxygen.

The chemical reaction formula is:

1.4C₈H₁₈+17.8O₂→11.2CO₂+12.6H₂O

∵ The molecular weight of C₈H₁₈ is: (12*8)+(1*18)=114

∵ Once the consumed oxygen is 17.8 mole/min, the required C₈H₁₈ is

=>114 g/mole*1.4 mole/min=159.6 g/min

=>159.6 g/min*60 min/hr=9576 g/hr=9.6 kg/hr

E. The relation between the oxygen content of the exhaust and the de-nitrified efficiency:

The experimental result shows the oxygen content of the exhaust is inversely proportional to the de-nitrified efficiency of the exhaust after catalyst reaction, that is, the less the oxygen is contained in the exhaust, the lower the consistency of nitrogen oxide (NOx) is provided in the exhaust after catalyst reaction. On the contrarily, the more the oxygen is contained in the exhaust, the worse the de-nitrified efficiency is.

F. Calculation and measurement for the oxygen content of the exhaust and the oxygen remover:

i) The oxygen content of the exhaust can be measured at both the front end and the rear end of the catalyst bed for calculating the amount of the oxygen remover needed.

ii) When the ingredients in the exhaust and the flow rate of the exhaust are fixed, the oxygen content of the exhaust can be assumed to be unchanged after being measured such that the required fixed oxygen remover can be figured out.

iii) When the ingredients in the exhaust is fixed and the flow rate of the exhaust is changed, the oxygen content thereof can be detected after being measured and the quantity of the required injected oxygen remover can be figured out by way of the variation of the flow rate.

iv) When the ingredients in the exhaust and the flow rate of the exhaust are changed with respect to the state of the oxygen removing reaction, it is necessary to measure the oxygen content by way of oxygen detecting device and the measured signal is sent to a calculation control system such that the required injected oxygen remover can be figured out.

※ The oxygen detecting device is placed at the front end of the catalyst bed to perform the measurement.

G. The choice of the catalyst:

An oxidation-reduction catalyst is used.

H. The choice of the loader for the catalyst:

i) The honeycomb metal loader;

ii) The honeycomb ceramic loader;

iii) The foamed ceramic loader;

iv) The plate loader.

※ 100 cell/in² (the number of holes in an area per square inch) honeycomb metal loader is adopted.

I. The reaction temperature and the reaction efficiency of the de-nitrified catalyst:

A range of the reaction temperature of the de-nitrified catalyst is 100-610° C. and the higher the temperature is, the better the de-nitrified efficiency is in the range.

※ The operation temperature of the present embodiment is 475° C.

J. The initial cost and the operation cost are lowered:

It is about 70-80% the initial and the operation cost used in the selective catalyst reduction

It is appreciated that the present invention has offered an effective method with lower cost to reduce, and even more, to remove the nitrogen oxide in the discharged exhaust. Accordingly, the present invention has a remarkable contribution for both of the industries and the environment protection.

While the invention has been described with reference to preferred embodiments thereof, it is to be understood that modifications or variations may be easily made without departing from the spirit of this invention, which is defined by the appended claims.

What is claimed is:

1. A method for reducing nitrogen oxide with a catalyst, comprising:
a step of guiding exhaust, guiding the exhaust containing the nitrogen oxide into a catalyst apparatus after a consistency of oxygen in the exhaust being controlled in a certain range;
a step of catalytic reaction, converting the exhaust having been guided into the catalyst apparatus with a catalyst; and
a step of discharging, discharging the exhaust having been converted with the catalyst.

2. The method for reducing nitrogen oxide with a catalyst according to claim 1, a step of introducing an oxygen remover and a step of oxygen removing reaction can be added in case of an oxygen content of the exhaust being higher than a preset value and the steps are performed by way of introducing the oxygen remover into the exhaust and the oxygen content (the consistency of oxygen) being reduced through the oxygen removing reaction.

3. The method for reducing nitrogen oxide with a catalyst according to claim 2, wherein the preset oxygen content (the consistency of oxygen) has 0˜5% consistency.

4. The method for reducing nitrogen oxide with a catalyst according to claim 2, wherein an oxygen removing reaction room may be added to facilitate the exhaust being guided and a conveying pump or a windmill may be provided to send the oxygen remover to the reaction room.

5. The method for reducing nitrogen oxide with a catalyst according to claim 2, wherein the oxygen remover can be selected from organic complex such as gasoline, diesel fuel, heavy oil, kerosene, stain removing oil, gas, natural gas, coal, hydrogen, methanol, ethanol, propanol, butanol, methane, ethane, propane, benzene or bio-oil refined from plants, or acutely oxidized reactive metal such as sodium or magnesium, or oxygen remover such as the powder (nitride).

6. The method for reducing nitrogen oxide with a catalyst according to claim 2, wherein the step of the oxygen removing reaction can be added with an ignition device to cause the oxygen removing reaction; the ignition device can a spark stick, a flame, a coil, a spark generator or the like to allow the oxygen remover causing a phenomenon of acute oxidation so as to remove the oxygen in the exhaust.

7. The method for reducing nitrogen oxide with a catalyst according to claim 2, wherein the step of oxygen removing reaction can detect the consistency of the oxygen in the exhaust by way of an oxygen detecting device and can detect temperature, pressure and flow rate of the exhaust by way of a detecting device for measuring the temperature, the pressure and the flow rate and the detected values are acted as parameters for a introduced amount of the oxygen remover.

8. The method for reducing nitrogen oxide with a catalyst according to claim 1, wherein the catalyst used in the step of catalytic reaction is an oxidation-reduction catalyst and the catalyst preferably is precious metal such as Pt, Pd and Rh, Ag, or ordinary metallic oxide such as Al, Cu, Fe, Mn, Co, Cr and V, or rare earth family such as series of La or series of Ac.

9. The method for reducing nitrogen oxide with a catalyst according to claim 2, wherein the catalyst used in the step of catalytic reaction is an oxidation-reduction catalyst and the catalyst preferably is precious metal such as Pt, Pd and Rh, Ag, or ordinary metallic oxide such as Al, Cu, Fe, Mn, Co, Cr and V, or rare earth family such as series of La or series of Ac.

10. The method for reducing nitrogen oxide with a catalyst according to claim 1, wherein the step of catalytic reaction may be added with a reducing agent trough for a amount of reducing agent being injected with a proper amount of reducing agent based on need and a detection device for the consistency of nitrogen oxide prior to the reaction and/or after the reaction so as to control the injected amount of the reducing agent.

11. The method for reducing nitrogen oxide with a catalyst according to claim 2, wherein the step of catalytic reaction may be added with a reducing agent trough for a amount of reducing agent being injected with a proper amount of reducing agent based on need and a detection device for the consistency of nitrogen oxide prior to the reaction and/or after the reaction so as to control the injected amount of the reducing agent.

12. The method for reducing nitrogen oxide with a catalyst according to claim 1, wherein a detection for consistency of oxygen and a detection for temperature, pressure and flow rate may be performed after the step of catalytic reaction.

13. A system for reducing nitrogen oxide with a catalyst, comprising:
an exhaust guiding apparatus, guiding exhaust containing the nitrogen oxide into a catalyst apparatus after a consistency of oxygen in the exhaust being controlled in a certain ranged;
a catalytic reaction apparatus, communicating with the exhaust guiding apparatus and treating the exhaust with a catalytic reaction; and
a discharging apparatus, communicating with the catalytic reaction apparatus and discharging the exhaust having been reacted with the catalyst.

14. The system for reducing nitrogen oxide with a catalyst according to claim 13, wherein an oxygen remover trough can be added to communicate with an oxygen reaction room and the oxygen reaction room further communicates with the exhaust guiding apparatus and the catalytic reaction apparatus respectively so that the oxygen remover can be injected into the exhaust with oxygen content higher than a preset value for creating an oxygen removing reaction; and a reducing agent trough may be added to communicate with the catalytic reaction apparatus so that a proper reducing agent can be injected into the reducing agent trough to facilitate the catalytic reaction.

15. The system for reducing nitrogen oxide with a catalyst according to claim 13, wherein the oxygen content preset value is 0˜5% consistency.

16. The system for reducing nitrogen oxide with a catalyst according to claim 14, wherein the oxygen remover trough is provided with an external delivery pump or an external windmill to deliver and guide the oxygen remover into the reaction room.

17. The system for reducing nitrogen oxide with a catalyst according to claim 14, wherein an oxygen detection device and/or a device for detecting temperature, pressure, and flow rate can be provided between the oxygen removing reaction room and the catalytic reaction device to offer parameters for introducing the oxygen remover into the oxygen removing reaction room.

18. The system for reducing nitrogen oxide with a catalyst according to claim 14, wherein a device for detecting consistencies of oxygen and nitrogen oxide and/or a device for detecting temperature, pressure and flow rate can be added between the catalytic reaction apparatus and the discharging apparatus to detect the consistency of oxygen and/or temperature, pressure and flow rate after the catalytic reaction.

19. The system for reducing nitrogen oxide with a catalyst according to claim 13, wherein the catalyst in the catalytic reaction apparatus is an oxidation-reduction catalyst and the catalyst preferably is precious metal such as Pt, Pd and Rh, Ag, or ordinary metallic oxide such as Al, Cu, Fe, Mn, Co, Cr and V, or rare earth family such as series of La or series of Ac.

20. The system for reducing nitrogen oxide with a catalyst according to claim 14, wherein the catalyst in the catalytic reaction apparatus is an oxidation-reduction catalyst and the catalyst preferably is precious metal such as Pt, Pd and Rh, Ag, or ordinary metallic oxide such as Al, Cu, Fe, Mn, Co, Cr and V, or rare earth family such as series of La or series of Ac.

21. The system for reducing nitrogen oxide with a catalyst according to claim 14 wherein the oxygen remover can be selected from organic complex such as gasoline, diesel fuel, heavy oil, kerosene, stain removing oil, gas, natural gas, coal, hydrogen, methanol, ethanol, propanol, butanol, methane, ethane, propane, benzene or bio-oil refined from plants, or acutely oxidized reactive metal such as sodium or magnesium, or the oxygen remover such as the powder (nitride).
